(19) United States
(12) Patent Application Publication
(10) Pub. No.: US 2007/0055874 A1
(43) Pub. Date: Mar. 8, 2007

(54) Bundled subscriber authentication in next generation communication networks

(75) Inventors: Son Phan-Anh, Budapest (HU); Auvo Hartikainen, Tampere (FI); Bryan Gleeson, San Jose, CA (US); Georg Mayer, Helsinki (FI); Mikko Aittola, Tampere (FI); Minna Myllymaki, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/332,227

(22) Filed: Jan. 17, 2006

(30) Foreign Application Priority Data
Sep. 5, 2005 (EP) 05019219.4

(51) Int. Cl. H04L 9/00

(52) U.S. Cl. 713/168

(57) ABSTRACT

Performing an authentication of a subscriber in a communication system comprising at least two subsystems is disclosed, the authentication of the subscriber requiring authentications of the subscriber in any of the subsystems, the method performing a bundled subscriber authentication by using an authentication in a first one of the subsystems for an authentication in a second one of the subsystems.

### FIELD OF THE INVENTION

The present invention relates to methods, network elements, means, systems and computer programs for providing a bundled subscriber authentication in next generation communication networks. In particular, the present invention relates to subscriber authentication in subsystems of a convergence network such as for example 3GPP (“Third Generation Partnership Project”) or TISPAN (“Telecommunications and Internet converged Services and Protocols for Advanced Networking”) networks.

### BACKGROUND OF THE INVENTION

In recent years, communication technology has widely spread in terms of number of users and amount of use of the telecommunication services by the users. This also led to an increase in the number of different technologies and technological concepts in use.

Accordingly, there is a need for convergence of networks and systems based on such different technologies and technological concepts into overall network systems. Further, there is a need for convergence of different services, functions and applications into overall network systems. Such converged network systems are often called next generation networks. Examples for such next generation networks include 3GPP and TISPAN networks as mentioned above.

For ensuring security and trustiness within such overall network systems, which is particularly important for functions and services related to security-relevant, personal and/or confidential data, and for controlling access to such network systems and parts thereof, subscriber authentication is usually performed. However, there is a problem that such an authentication is to be performed for any subnetwork or subsystem within an overall network system, to which e.g. a subscriber whishes to get access. This is expensive for example in terms of time and transmission capacity consumed for all authentication procedures as well as delivery and/or distribution costs of authentication credentials to subscribers.

As an example scenario for a next generation network for the purpose of illustrating the present invention and its underlying problems, reference is made to the above-mentioned TISPAN network architecture.

FIG. 1 of the accompanying drawings exemplarily shows a functional TISPAN network architecture according to the document “Draft ETSI ES 282 001, v.1.1.7, Release 1” of May 2005. (Note: ETSI=“European Telecommunications Standards Institute”.) The functional block diagram of FIG. 1 should be self-explanatory for a skilled person. Thus and since the TISPAN next generation network is only used as an illustrative example, reference is made to the document referred to above for any details.

With reference to FIG. 1, it is to be noted that the TISPAAN network architecture comprises several subsystems such as for example a network attachment subsystem NASS and a (core) IP (Internet Protocol) multimedia subsystem IMS.

The NASS is an access-level subsystem and provides registration at access level and initialization of user equipment for accessing to the TISPAN services. The NASS further provides network level identification and/or authentication, manages the IP address space of an access network connected thereto and authenticates access sessions. Network attachment through the NASS is based on implicit or explicit (user) subscriber identity and authentication credentials stored in the NASS. Thus, it is obvious that the NASS deals with some kind of access level authentication. Further information and details about the NASS and its functional architecture can be gathered e.g. from the document “Draft ETSI ES 02021, v.0.4.2, Release 1” of May 2005.

The (core) IMS supports the provision of SIP-based multimedia services to subscribers or respective user equipments, wherein SIP stands for a session initiation protocol which is known to a skilled person. For this purpose, the IMS also has to deal with some kind of subscriber authentication.

FIG. 2 of the accompanying drawings shows a block diagram illustrating interfaces of the (core) IMS according to FIG. 1. It can be gathered from FIG. 2 that there exists an interface between the IMS and the NASS. Further details about the IMS and its functional architecture can be gathered e.g. from the document “Draft ETSI ES 2XX XXX, v.1.1.6, Release 1” of June 2005.

Accordingly, the two subsystems, i.e. the network attachment subsystem NASS and the IP multimedia subsystem IMS, normally perform separate authentication procedures for end users, i.e. subscribers.

For providing security, i.e. authentication, in an IMS-related network environment, there has been proposed a solution usually referred to as “Early IMS Security”. This solution is e.g. disclosed in the document “3GPP TR 33.978, v.6.1.0 (Release 6)” of June 2005. The thus disclosed solution provides for an access-level bundled authentication for a 3GPP (R6) architecture. However, it is a disadvantage of this solution that it is only applicable for GPRS (“General Packet Radio Service”) access technology. Thus, it is not suitable for any other access technology used such as CDMA (“Code Division Multiple Access”), an access network using a TISPAN architecture, or any future access technology.

However, since the above-mentioned solution has been a very early one and relates to an early stage of deployment of IMS networks (as an example of convergence networks), it has already been implemented in numerous user equipments and terminals in use today.

Furthermore, there have been made proposals by France Télécom and Huawei for a NASS-IMS-bundled authentication mechanism for use in a TISPAN network architecture environment. These proposals have been presented in the documents “ETSI TISPAN#06Bis, 06bTD078” and “ETSI TSPAN#7, 07TD175”, respectively. According to the thus proposed reuse of NASS-level authentication for IMS authentication, the actually distinct authentication procedures of NASS and IMS are combined.

However, the proposals exhibit several drawbacks as regards their implementations and operations. For example, it is detrimental that in these proposals authentication is performed by comparing information provided by an access network or user equipment with information also provided by an access network or user equipment. This approach is obviously not secure.

Further, it is disadvantageous that considerable changes to the existing TISPAN architecture are needed, and even more important that additional requirements towards the user equipment used by a subscriber are imposed thereby. These requirements cause several changes to existing user equipments and thus break a backward compatibility with existing user equipments compliant with “Early IMS Security”. Further, the binding of NASS-level and IMS-level identities is not logical in such a way that a smooth implementation and operation is ensured.

Thus, a solution to the above problems and drawbacks of known prior art proposals is needed for providing an improved bundled subscriber authentication in next generation communication networks.

### SUMMARY OF THE INVENTION

Consequently, it is an object of the present invention to remove the above drawbacks inherent to the prior art and to provide accordingly improved methods, network elements, means, systems and computer programs.

Accordingly, the invention provides methods, network elements, means, systems and computer programs as described in the present description, drawings and/or claims.

According to a first aspect of the invention, there is provided a method according to claim 1.

According to a second aspect of the invention, there is provided a system according to claim 19.

According to a third, fourth, and fifth aspect of the invention, there is provided a network element according to claims 36, 42, and 48, respectively.

According to a sixth aspect of the invention, there is provided a computer program product according to claim 54.

Further advantageous developments, features and modifications are set out in the respective dependent claims. The thus presented features can be realized in any combination conceivable.

Stated in other words, the present invention and its embodiments provide a solution for (re-)using a NASS-level (or TISPAN access-level) authentication for an IMS subscriber authentication. Thereby, it is taken advantage of the fact that an IMS authentication can rely on a successful NASS-level authentication in order to provide a “single-sign-on”-type authentication approach.

Thus, it is advantageous that the present invention provides for a more seamless and a more practical usage of one of the subsystems of a next generation network, e.g. the IMS subsystem. This is particularly advantageous in an early deployment phase of such networks and (sub-) systems.

Furthermore, the following advantages and benefits are provide by the present invention and its embodiments:

the compatibility on terminal level with earlier solutions such as “Early IMS Security” is maintained;

changes are kept completely within the network implementation; and

a seamless inter-working with existing terminals and user equipments is ensured, such as those on an “Early IMS Security” implementation base.

The transparency toward a terminal not only provides for backward compatibility with earlier terminals, but also makes the mechanism applicable for terminals which implement a core set of the session initiation protocol only. Their support is desirable (or even essential) in an early deployment phase of convergence networks.

The present invention and its embodiments introduce an improvement to known solutions and/or proposals for example by formulating a logically cleaner solution and solving the backward compatibility problem as mentioned above. Advantageously, the changes to the TISPAN architecture are kept at minimum level and the binding of NASS-level and IMS-level identities is kept simple by the embodiments of the present invention.

According to embodiments of the present invention, particularly by making an authorization header optional, there is maintained the possibility to enrich the functionality for example with:

a concurrent registration of a single private user identity to several terminals, or

a support of a so-called “family subscription” use case (explained in more detail below).

### BRIEF DESCRIPTION OF THE DRAWINGS

In the following, the present invention will be described in greater detail with reference to the accompanying drawings, in which

FIG. 1 shows a functional TISPAN network architecture;

FIG. 2 shows a block diagram illustrating interfaces of the (core) IMS according to FIG. 1;

FIG. 3 consisting of FIGS. 3A and 3B shows a signaling diagram of a procedure according to an embodiment of the present invention;

FIG. 4 shows a functional network architecture according to an embodiment of the present invention; and

FIG. 5 shows a block diagram of network elements according to an embodiment of the present invention.

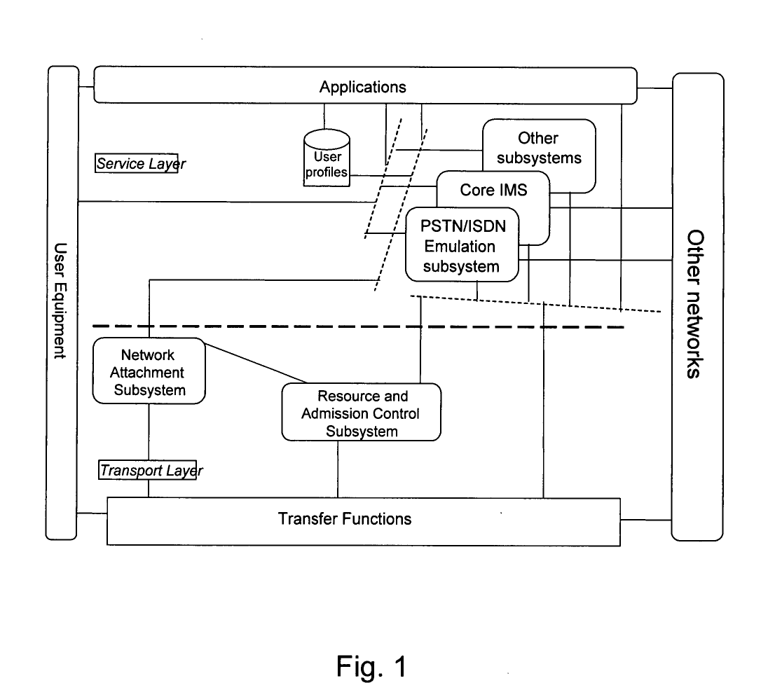

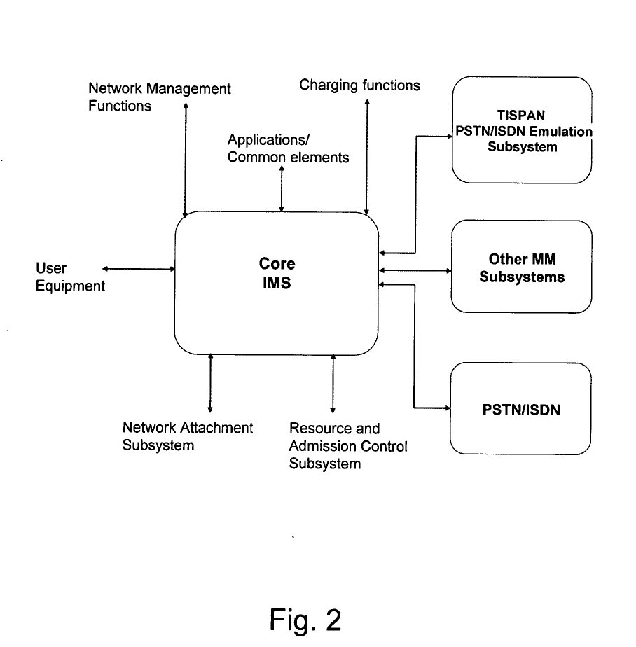

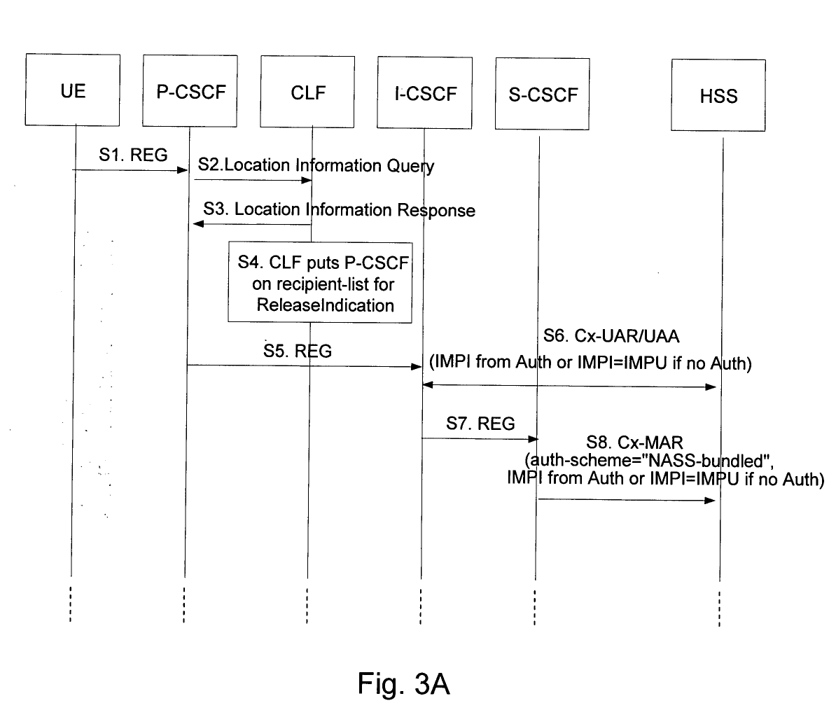

### DETAILED DESCRIPTION OF EMBODIMENTS OF THE PRESENT INVENTION

The present invention is described herein with reference to a particular non-limiting example. A person skilled in the art will appreciate that the invention is not limited to these examples, and may be more broadly applied.

In particular, the present invention is described in relation to the TISPAN architecture as set out above in connection with the NASS and IMS subsystems. As such, the description of the embodiments given herein specifically refers to terminology which is related to TISPAN, NASS and IMS. Such terminology is only used in the context of the presented examples, and does not limit the invention in any way.

Further, it is to be noted that the basic principles and implementation details of the present invention are described in the following by mainly referring to method steps and procedural aspects. However, it will be obvious for a skilled person that respective network elements, devices, systems comprising such network elements and devices, and computer programs being configured and/or adapted to perform the respective method steps and procedural aspects are also covered by the present invention.

Before describing the details of the present invention the following is to be noted.

The idea of reuse of access authentication for IMS subscriber authentication is rather similar to the “Early IMS Security”. Because of the “single-sign-on” nature of the both methods, their usage looks very same from the end-user's point of view: There is no IMS-specific authentication data/setting for the terminal but the whole IMS authentication is done “behind-the-scene” in a transparent manner toward the terminal reusing the access authentication. “Early IMS Security” is already used in many terminal implementation so incoming NASS-bundled authentication must maintain compatibility toward those terminals, as is already set out above.

This transparency to the terminal and compatibility with “Early IMS Security” at terminal level implies that the NASS-bundled authentication must not require any mandatory additional parameters compared to ones used in “Early IMS Security”. Specifically:

sending of an authorization header must not be mandatory for a user equipment UE; and

sending of additional parameters like access-subscriber-ID or access-network-ID must not be mandatory for a user equipment UE.

Though sending of an authorization header must not be made mandatory, it may be recommended if the UE is able to do so. The authorization header, which e.g. provides a private user identity (IMPI) explicitly, is very useful for the following purposes:

to facilitate concurrent registration with a single public user identity (IMPU) at several terminals; and

to support the “family-subscription” use case, where there is the same subscription and same bill (so same private user identity (IMPI)) is used for e.g. the whole family, each member having a separate public user identity (IMPU) for service differentiation (different target for messaging, different ringing tones, etc.).

### Embodiment 1

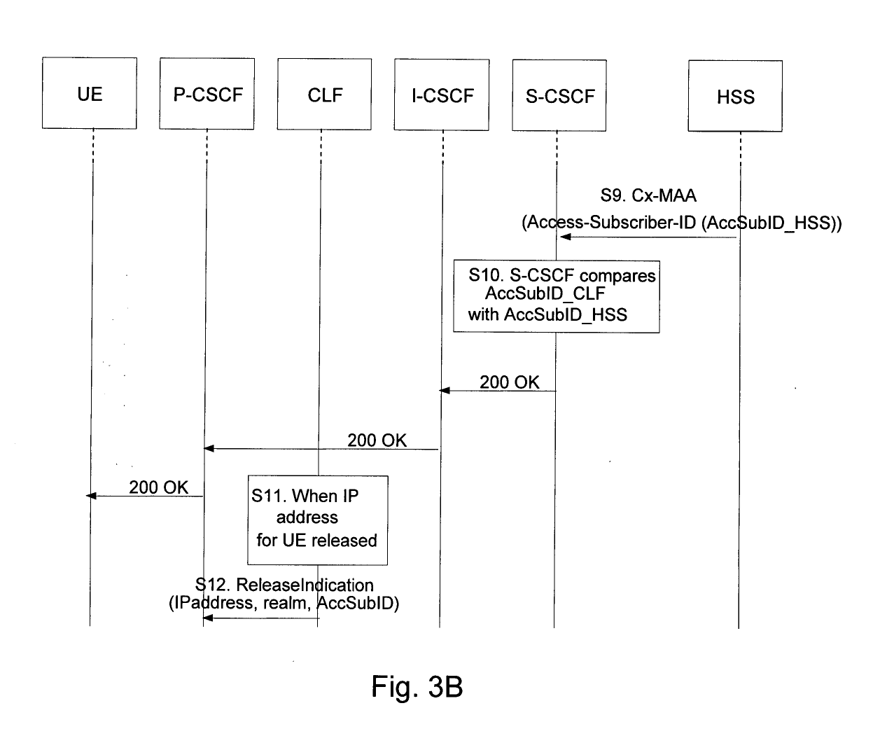

FIG. 3 consisting of FIGS. 3A and 3B shows a signaling diagram of a procedure according to an embodiment of the present invention. FIG. 3A shows the first part of the procedure and FIG. 3B shows the second part, the time passing from top to bottom and the individual figures being linked where the dashed lines are illustrated.

In FIG. 3, the signaling method is exemplarily performed between a user equipment UE, a proxy connection state control function P-CSCF, a connectivity session location and repository function CLF, an interrogating connection state control function I-CSCF, a serving connection state control function S-CSCF, and a home subscriber server HSS. All of these network elements and devices are basically known to a skilled person and details of them can be taken from the above-referenced documents. The P-, I- S-CSCF's and the HSS are part of the IMS subsystem, the CLF is part of the NASS subsystem according to the TISPAN architecture.

In a first step S1, the UE sends a REGISTER message to the P-CSCF of the IMS. The REGISTER message may contain or may not contain an authorization header. Then, the P-CSCF identifies the allocated IP address of the UE based on the source IP address in the received IP packet of the REGISTER message. The P-CSCF locates the CLF using as input the access network from which the P-CSCF receives the IP packet from the UE or the UE's IP address. It is to be noted that the P-CSCF may have several logical/physical interfaces toward different access networks.

In step S2 of FIG. 3A, the P-CSCF performs a “Location Information Query” toward the CLF over a predetermined interface called the e2 interface. The keys for the query are the IP address used by the UE and the addressing realm, i.e. domain, in which the IP address is significant. The P-CSCF identifies the IP addressing realm also based on some configuration means. The P-CSCF also puts a “ReleaseIndicationRequest” flag into the location information query to indicate to the CLF that it would like to receive a “IP Connectivity Release Indication” message from the CLF when the IP address allocated for the UE is released. Here, it is to be noted that the “ReleaseIndicationRequest” flag is currently not defined for a “Location Information Query” message, however its purpose may not be unique for the P-CSCF but common for other application functions also, so should be added to the “Location Information Query” message. An “IP Connectivity Release Indication” message is an already defined message used for an interface between the CLF and a resource access control facility RACF, called e4 interface, thus can be easily reused for the e2 interface.

In step S3, the CLF answers to the query with a “Location Information Response” message containing an access-subscriber-ID (hereinafter called AccSubID_CLF). The access-subscriber-ID from the CLF corresponds to the IP address used by the UE. Then, the CLF also puts the P-CSCF (i.e. the IP address of the P-CSCF) on a list of recipients for a “IP Connectivity Release Indication” message.

In step S5 of FIG. 3A, the P-CSCF forwards the REGISTER message, which it has received from the UE in step S1, to the I-CSCF. The REGISTER message in this step contains the identity AccSubID_CLF added by the P-CSCF and the authorization header, if any.

In step S6, the I-CSCF performs a UAR/UAA Cx operation with the HSS in order to find the S-CSCF, wherein Cx is a denotation for the interface between the I-CSCF and the HSS. The user authentication request/answer (UAR/UAA) operation is similar to one defined for “Early IMS Security”; except that if an authorization header (denoted by Auth in FIG. 3A) exists in the REGISTER message, then a private user identity (IMPI) is obtained from it instead of derived from a public user identity (IMPU).

Subsequently, the I-CSCF forwards the REGISTER message toward the S-CSCF in step S7. The REGISTER message in step S7 contains the identity AccSubID_CLF and the authorization header, if any. Thereupon in step S8, the S-CSCF performs a multimedia authentication request (MAR) Cx operation toward the HSS. The attribute value pair defining the “authentication scheme” is filled with a parameter denoting “NASS-bundled-authentication”. An IMPI (i.e. private user identity) is obtained from the authorization header, if it exists, and otherwise the IMPI is derived from the IMPU (i.e. public user identity), as is done in “Early IMS Security”.

Since the HSS is provisioned with a list of a static mapping between an IMPI and an access-subscriber-ID, the HSS can based on IMPI look-up the corresponding access-subscriber-ID (hereinafter called AccSubID_HSS) and returns it to the S-CSCF in a multimedia authentication answer (MAA) Cx message (step S9 of FIG. 3B).

The S-CSCF, in step S10 of FIG. 3B, processes the authentication bundled with NASS by comparing the identity AccSubID_CLF embedded in the REGISTER message received in step S7 with the identity AccSubID_HSS received from the HSS in step S9. If these are equal, the IMS authentication will succeed, which results in a transmission of an OK indication (“200 OK”) from the S-CSCF to the I-CSCSF, then from the I-CSCF to the P-CSCF, and finally from the P-CSCSF to the UE. This transmission of an OK indication is similar to a corresponding procedure in “Early IMS Security”.

At a later point in time (step S11), when the IP address allocated to the UE is released, the CLF sends a “IP Connectivity Release Indication” message to the P-CSCF which contains the IP address, addressing realm and access-subscriber-ID (step S12). The procedure as to how the P-CSCF can perform a release of an IMS registration for the UE is no aspect of the present invention.

It is an option of the present embodiment that the CLF query is performed by the S-CSCF instead of the P-CSCF.

Namely, the S-CSCF can also act in the role of an application function and query the CLF over the e2 interface mentioned above, if it can locate the CLF and identify the realm, i.e. domain, used by the UE. This solution may not be applicable in all network environments as locating the CLF and identifying the IP address realm in the S-CSCF is more problematic than in the P-CSCF. However this is also an alternative to consider, if it is desirable to build a home network centric solution for the problem while accepting some limitations that make locating the CLF in the S-CSCF possible.

For example, if only one global addressing realm is used, it can be configured directly to the S-CSCF.

Stated in other words, the proposed method according to the present embodiment has the following important modifications, which cause it be in line with the compatibility requirements related to earlier (e.g. “Early IMS Security”-related) terminals:

an authorization header is not mandatory, but just recommended;

neither an access-subscriber-ID nor an access-network-ID are required from the user equipment;

a CLF query is done based on an allocated IP address, and the result is an access-subscriber-ID bound to the allocated IP address; and

the HSS provides the S-CSCF with an access-subscriber-ID that is to be checked against an access-subscriber-ID originally provided by the CLF.

The main differences to a proposed solutions can be summarized as follows, wherein the advantages resulting from these differences are mentioned above.

1. No new parameters are needed in the REGISTER message from UE to P-CSCF, which allows backward compatibility with existing UE's.

2. The query from the P-CSCF to the CLF is done always with the IP address and the correct CLF is found based on configuration data in the P-CSCF. This means that based on the access network, where the terminal's REGISTER message comes from, the P-CSCF can decide which one is the correct address for the CLF query.

3. The ‘ReleaseIndicationRequest’ parameter in the CLF query is used to indicate to the access network that it should inform the P-CSCF, if/when an access network connection is released.

4. The CLF returns the access-subscriber-ID which is then forwarded from the P-CSCF to the S-CSCF.

5. The HSS query is not only done to check the authentication method, but to check the authentication method and to get the access-subscriber-ID provisioned by an operator.

6. The S-CSCF does not compare the IP address received from the CLF against the IP address of the REGISTER message received from the UE, but compares the access-subscriber-ID received from the CLF against the access-subscriber-ID received from the HSS.

However, for further SIP messages received from the UE, just the IP address is used to check that they are from the correct UE (whereby it is to be noted that after registration the S-CSCF stores the source IP address and it is compared against the IP address in further SIP messages).

7. The P-CSCF can release the IMS registration based on an ‘IP connectivity release’ message from the CLF.

8. An authorization header may or may not be present in the REGISTER message, which allows backward compatibility with so-called ‘Early IMS’ terminals.

### Embodiment 2

According to another embodiment of the present invention, the basic principle of “Early IMS Security” is adopted.

The “Early IMS Security” is currently specified for GPRS access only, as is already mentioned above. However, according to the present embodiment of the invention, the “Early IMS Security” approach is extended to non-GPRS access.

The main differences to a current “Early IMS Security” authentication mechanism can be summarized as follows.

1. An authorization header in the REGISTER message is recommended, but not mandatory (to keep a backward compatibility with current early IMS implementation in terminals). If an authorization header is available, the I-CSCF/S-CSCF obtains an IMPI from there, otherwise an IMPI is derived from an IMPU as in the current “Early IMS Security” procedure.

2. The allocated IP address is pushed to the HSS not from a GGSN (Gateway GPRS Support Node), but from the CLF. Furthermore, an IP addressing realm is pushed from the CLF and it may be used in the authentication process in addition to an IP address.

3. The identity of the subscriber, which is used in the access network and is pushed from the CLF to the HSS, is not necessarily a MSISDN (Mobile Station ISDN Number).

In order to be able to perform the authentication method of the present embodiment, the CLF must be able to locate the HSS. To this end, it is an option that application AAA-server addresses (e.g. address of subscription locator function SLF and/or home subscriber server HSS) of the subscriber are configured to the AAA-server of the access network.

In this case, an access network AAA-server (AAA: authentication, authorization and accounting) updates the IP address to an application AAA-server.

In the following, it is described how the above option can be implemented in a TISPAN environment. However, the same principle can similarly be applied with other access networks and/or AAA-servers.

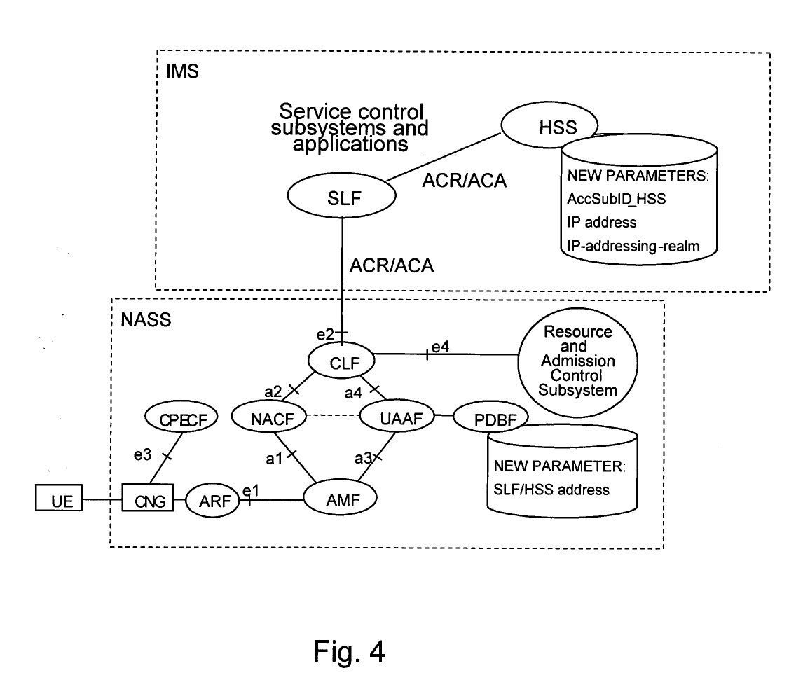

FIG. 4 shows a functional network architecture according to the present embodiment of the present invention, which is underlying the following description.

The NASS defined by TSIPAN includes a functional entity called CLF (connectivity session location and repository function), which has an e2 interface towards a Service/Application subsystem, e.g. an IMS subsystem. To adapt the ‘Early IMS Security’ authentication to such a TISPAN architecture as shown in FIG. 4, the e2 interface can be used to push the access network connection establishment and release information from the NASS to the IMS, more specifically to the SLF or the HSS (which is equivalent to a user profile sever function UPSF in TISPAN terms). Based on that information, the IMS is able to execute the IP address based authentication as specified in “Early IMS Security”.

According to the present embodiment, the following changes and functionalities are provided in the NASS and the IMS, which are needed for the above-described procedure:

As new data in the NASS the following is to be mentioned: the address of an IMS subscriber's SLF or HSS is part of the subscriber's access profile, which is stored in a profile database function PDBF. The SLF or the HSS address is delivered to the CLF by a user access authentication function UAAF in a so-called “Access Profile Push” operation.

Thus, according to the present embodiment, the SLF or HSS address is stored (at the CLF or PDBF) to access subscription data of the subscriber independently and individually on a subscriber basis. Because of this, the access network is able to locate the SLF/HSS of the IMS network of the subscriber and to send the required access network information (IP addresses etc.) to the SLF/HSS.

It is a further advantage of this feature of the present embodiment that there is no restriction that the access network must be the same as the home network of the subscriber i.e. there is no need that the same operator must operate the access network and the IMS network. Accordingly, the same access network and access authentication can be used to access IMS networks operated by different operators. Furthermore, it is possible to use the same IMS network from different access networks.

As new data in the IMS the following is to be mentioned: the SLF and/or the HSS (i.e. UPSF) database has a subscription specific field to store an access network subscriber-ID (AccSubID_HSS). Yet, in case the identity AccSubID_HSS equals the subscriber's existing IMS private or public identity (IMPI or IMPU), there is no need to store AccSubID_HSS separately. Additionally, the HSS database has a subscription specific flag that defines that a subscriber is allowed to use a NASS-bundled authentication for IMS access. The HSS must also have the ability to store the IP address and IP addressing realm of the subscriber received from the CLF.

When a subscriber of this kind of next generation network activates an access connection, the IP address is allocated and the subscriber is authenticated implicitly or explicitly as defined in the NASS architecture document mentioned above. After an successful access level authentication, the CLF sends an Accounting-Request (ACR) Diameter message to the SLF/HSS address defined for that subscriber. This message contains the subscriber's ID in the access network (AccSubID_CLF), the IP address allocated for the subscriber and optionally the IP addressing realm. A parameter “Accounting-Report-Type” with a value “Start-Record” is used in the ACR message to indicate an establishment of an access network connection.

Also the following is to be noted: The ACR message is currently not used on the e2 interface, but the possibility to use it is noted in current specifications concerning the “Early IMS Security”. Instead of ACR/ACA also Diameter messages AAR (AA-Request) and AAA (AA-Answer) could be used. It is also possible to utilize the “Access Profile Push” operation that is defined for the e4 interface between the CLF and a resource and admission control subsystem RACS or it could be said that an “Access Profile Push” is mapped to ACR in this case.

Further, the SLF routes the Diameter message to the correct HSS, if necessary. The HSS checks whether the identity AccSubID_CLF matches with the identity AccSubID_HSS. The HSS sends an acknowledgement to the CLF with an Accounting-Answer (ACA) message. The CLF may deny the IP connection if the ACR/ACA procedure to the SLF/HSS fails according to local policy.

When the UE initiates an IMS registration, the IMS authentication is according to “Early IMS Security”. If the IP addresses are not globally unique, the following addition is needed: IP addressing realm is identified in the P-CSCF on the basis of an configuration and carried to the S-CSCF. The IP address is carried in a parameter “received via” as in “Early IMS Security”, but a new via parameter called “received-realm” should be introduced to carry realm information to the S-CSCF.

A change on the Cx interface is also needed to get the IP addressing realm value from the HSS to the S-CSCF. The S-CSCF is then able to compare the realm it receives from the P-CSCF to the realm stored by the HSS.

In case an access level connection is released, the CLF informs the HSS by sending an ACR diameter message to the SLF/HSS address defined for the subscriber in the PDBF. A parameter “Accounting-Report-Type” with a value “Stop-Record” is used in the ACR message to indicate a release of an access network connection. The ACR message contains also the identity AccSubID_CLF, the IP address, and the IP addressing realm. The HSS checks the received parameters against the ones stored in the HSS and deletes the subscriber's IP address.

In this regard, the following is to be noted: If Diameter AAR/AAA is used to indicate an IP connection establishment, STR/STA (Session-Termination-Request/Answer) is used to indicate the termination thereof. It is also possible to utilize a message “IP Connectivity Release Indication” on the e4 interface or it could be said that an “IP Connectivity Release Indication” is mapped to ACR in this case.

Finally, the HSS sends an ACA Diameter message to the CLF and starts an HSS-initiated de-register procedure towards the S_CSCF, if the UE is registered.

In short, the CLF according to the present embodiment stores an address of the SLF or HSS and sends the access network information (i.e., for example, IP address, IP addressing realm, AccSubID_CLF) to that address, when an access network connection is established. Further, the CLF sends an ACR to the HSS, when an access connection is released. The HSS compares the identities AccSubID_CLF and AccSubID_HSS before storing the IP address as customary. The HSS according to the present embodiment also stores the IP addressing realm. The S-CSCF gets the IP addressing realm from the HSS (in MAA Cx operation, which is an answer operation to MAR operation). To this end, as mentioned above, a new parameter ‘received-realm’ is needed to carry the realm information from the P-CSCF to the S-CSCF in the REGISTER message. The S-CSCF compares the realm from the P-CSCF and that from the HSS to ensure that the message came from the correct realm. This is in addition to normal IP address comparison (comparing IP addresses from the P-CSCF and from the HSS.

It has to be noted that the above scenario and the underlying network architecture represents an illustrative example of the present embodiment of the invention. Hence, as regards the above-described feature of storing the SLF or HSS address to the CLF, this also represents an example with respect to the underlying example network architecture. Stated in more general terms, such a storing operation is to be regarded as a storing an address of a network element that is able to locate the HSS of the subscriber and to route messages from the access network to the HSS.

Accordingly, the present embodiment is also applicable to a case where there is a network element between the CLF and the HSS, such as for example a Diameter relay agent or a Diameter proxy agent. In such a case it is possible that for example the address of the Diameter relay or proxy agent of the IMS network of the subscriber is stored to the access network (instead of the SLF or HSS address, as exemplarily described above).

### Embodiment 3

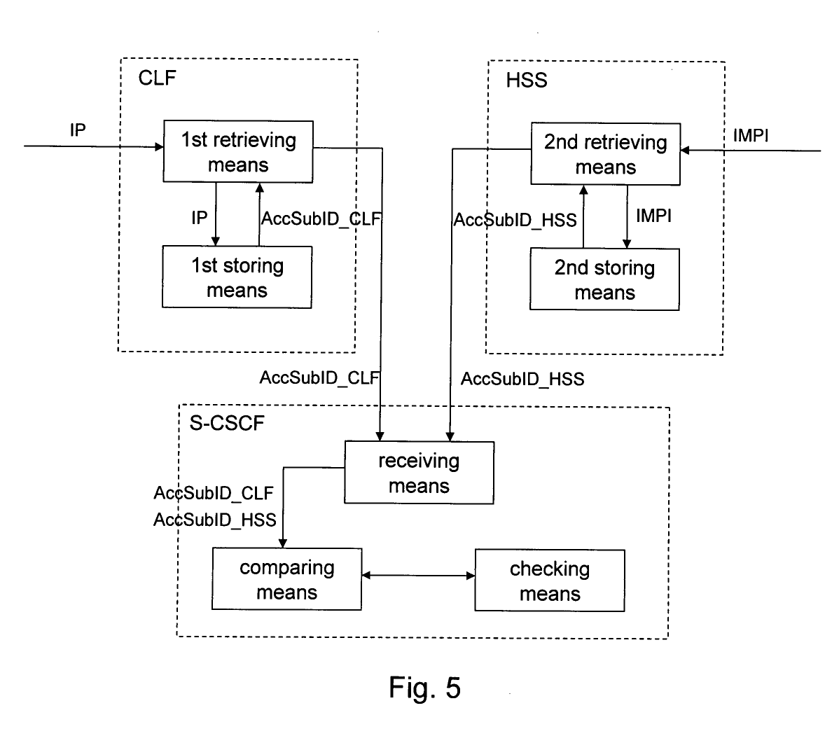

FIG. 5 shows a block diagram of network elements according to an embodiment of the present invention. Thus, there is likewise a system according to an embodiment of the present invention. The below description basically refers to FIG. 5 but is also applicable to the embodiments of FIGS. 3 and 4.

It is to be noted that FIG. 5 only represents an exemplary illustration of network elements of the present invention, That is, the illustration is not complete, and thus the network elements depicted can also comprise further means and the system depicted can also comprise further network elements or other devices such as a user equipment.

According to the embodiment illustrated by FIG. 5, a first network element of a first subsystem, e.g. the NASS, is exemplarily denoted by CLF. The CLF comprises first retrieving means for retrieving a first subscriber identity AccSubID_CLF. This identity is retrieved from first storing means for storing such identity by means of a network level address of the subscriber to be authenticated, e.g. an IP address as indicated by “IP” in FIG. 5.

According to the embodiment illustrated by FIG. 5, a second network element of a second subsystem, e.g. the IMS, is exemplarily denoted by HSS. The HSS comprises second retrieving means for retrieving a second subscriber identity AccSubID_HSS. This identity is retrieved from second storing means for storing such identity by means of a private user identity of the subscriber to be authenticated, e.g. IMPI.

The two subscriber identities retrieved are transferred to a third network element of the first or second subsystem. They are received by receiving means of the third network element which is exemplarily denoted by S-CSCF. In comparing means of the S-CSCF, the two subscriber identities of the first and second subsystems, i.e. AccSubID_CLF and AccSubID_HSS, are compared. Additionally or alternatively, the two subscriber identities of the first and second subsystems, i.e. AccSubID_CLF and AccSubID_HSS, are checked in checking means of the S-CSCSF as to whether they belong to the same user or subscriber.

In response to the result of the comparing and/or checking operations, it is determined whether or not the authentication of the subscriber is successful. This is the case, if the two identities match and/or belong to the same subscriber.

Although the illustration of FIG. 5, merely by way of example, mainly relates to the procedures according to Embodiment 1 above, it is clear for a skilled person that it is likewise applicable to the procedures according to Embodiment 2. For this purpose, only some minor modifications are needed. For example, the identities AccSubID_CLF and AccSubID_HSS are compared in the HSS instead of in the S-CSCF. That is, the third network element is a home subscriber server HSS. Also, the CLF pushes the mentioned information (i.e. IP address, IP addressing realm and AccSubID_CLF) to the HSS representing the third network element, so information is not fetched from CLF based on IP address. To this end, the CLF or PDBF has to have storing means for storing the address of the SLF or HSS to access subscription data of the subscriber independently and individually on a subscriber basis. Thus, stated in general terms, the network elements and the system comprised of the network elements are configured to perform any of the methods for authentication as described throughout this description and/or the claims.

In general, it is also to be noted that the mentioned functional elements, e.g. comparing means according to the present invention can be implemented by any known means, either in hardware and/or software, respectively, if it is only adapted to perform the described functions of the respective parts. For example, the comparing means of the third network element can be implemented by any data processing unit, e.g. a microprocessor, being configured to compare the two subscriber identities supplied thereto as defined by the appended claims. The mentioned parts can also be realized in individual functional blocks or by individual devices, or one or more of the mentioned parts can be realized in a single functional block or by a single device. Correspondingly, the above illustration of FIG. 5 is only for illustrative purposes and does not restrict an implementation of the present invention in any way.

Furthermore, method steps likely to be implemented as software code portions and being run using a processor at one of the peer entities are software code independent and can be specified using any known or future developed programming language such as e.g. C, C++, and Assembler. Method steps and/or devices or means likely to be implemented as hardware components at one of the peer entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

There are disclosed means and functions for performing an authentication of a subscriber in a communication system comprising at least two subsystems, the authentication of the subscriber requiring authentications of the subscriber in any of the subsystems, the method performing a bundled subscriber authentication by using an authentication in a first one of the subsystems for an authentication in a second one of the subsystems.

Even though the invention is described above with reference to the examples according to the accompanying drawings, it is clear that the invention is not restricted thereto. Rather, it is apparent to those skilled in the art that the present invention can be modified in many ways without departing from the scope of the inventive idea as disclosed in the appended claims.

1. A method for performing an authentication of a subscriber in a communication system comprising at least two subsystems, the authentication of the subscriber requiring authentication of the subscriber in any of the subsystems, the method performing a bundled subscriber authentication by using a first authentication in a first one of the subsystems for a second authentication in a second one of the subsystems, both the first authentication and the second authentication being based on subscriber identities.

2. The method according to claim 1, further comprising a step of:
comparing a first subscriber identity of the first subsystem with a second subscriber identity of the second subsystem.

3. The method according to claim 2, further comprising a step of:
checking whether the first subscriber identity and the second subscriber identity belong to a same subscriber.

4. The method according to claim 2, further comprising a step of retrieving the first subscriber identity during authentication in the second subsystem.

5. The method according to claim 4, wherein the step of retrieving the first subscriber identity is performed by means of a network level address of the subscriber.

6. The method according to claim 4, wherein the step of retrieving the first subscriber identity is performed at a first network element of the first subsystem.

7. The method according to claim 4, wherein the step of retrieving the first subscriber identity further comprises a step of:
querying location information of the subscriber.

8. The method according to claim 4, wherein the step of retrieving the first subscriber identity further comprises a step of:
sending a request, from a proxy network element of the second subsystem to a first network element of the first subsystem, for requesting the first network element to indicate a release of a network level address of the subscriber.

9. The method according to claim 8, further comprising a step of:
indicating, from the first network element to the proxy network element, when the network level address is released.

10. The method according to claim 8, wherein the proxy network element is a proxy serving connection state control function, P-CSCF.

11. The method according to claim 2, further comprising a step of retrieving the second subscriber identity during authentication in the second subsystem.

12. The method according to claim 11, wherein the step of retrieving the second subscriber identity is performed by means of a private user identity of the subscriber.

13. The method according to claim 12, wherein the step of retrieving the second subscriber identity is performed at a second network element of the second subsystem.

14. The method according to claim 1, further comprising a step of:
using an authorization header sent from the subscriber when initiating authentication for providing a private user identity of the subscriber.

15. The method according to claim 1, further comprising a step of:
comparing a first network level addressing realm of the subscriber from a first network element with a second network level addressing realm of the subscriber from a second network element.

16. The method according to claim 1, further comprising a step of:
storing, at a first network element of the first subsystem, an address of a network element of the second subsystem to a subscription of the subscriber on a subscriber basis.

17. The method according to claim 1, wherein the method is based on security aspects of an early IP multimedia subsystem in accordance with Third Generation Partnership Project (3GPP) specifications.

18. The method according to claim 1, wherein the communication system is in accordance with European Telecommunications Standards Institute (ETSI) specifications for telecommunication and Internet converged services and protocols for advanced networking, TISPAN.

19. A system for authentication of a subscriber in a communication system comprising at least two subsystems, the authentication of the subscriber requiring authentications of the subscriber in any of the subsystems and being performed by means of a bundled subscriber authentication by using a first authentication in a first one of the subsystems for a second authentication in a second one of the subsystems, both the first authentication and the second authentication being based on subscriber identities.

20. The system according to claim 19, comprising:
a first network element of the first subsystem;
a second network element of the second subsystem; and
a third network element of the first or the second subsystem.

21. The system according to claim 20, wherein the first network element comprises:
first means for storing a first subscriber identity of the first subsystem; and
first means for retrieving the first subscriber identity from the first means for storing.

22. The system according to claim 21, wherein the first means for retrieving is configured to retrieve the first subscriber identity by means of a network level address of the subscriber.

23. The system according to claim 20, wherein the first network element further comprises address storing means for storing an address of a particular network element of the second subsystem to a subscription of the subscriber on a subscriber basis.

24. The system according to claim 23, wherein the particular network element whose address is stored in the address storing means is operable to locate the third network element and to route messages to the third network element.

25. The system according to claim 20, wherein the second network element comprises:
second means for storing a second subscriber identity of the second subsystem; and
second means for retrieving the second subscriber identity from the second means for storing.

26. The system according to claim 25, wherein the second means for retrieving is configured to retrieve the second subscriber identity by means of a private user identity of the subscriber.

27. The system according to claim 20, wherein the third network element comprises:
means for receiving the first subscriber identity and the second subscriber identity; and
means for comparing the first subscriber identity and the second subscriber identity.

28. The system according to claim 27, wherein the third network element further comprises:
means for checking whether the first subscriber identity and the second subscriber identity belong to a same subscriber.

29. The system according to claim 19, wherein the system is based on security aspects of an early IP multimedia subsystem in accordance with Third Generation Partnership Project (3GPP) specifications.

30. The system according to claim 19, wherein the communication system is in accordance with European Telecommunications Standards Institute (ETSI) specifications for telecommunication and Internet converged services and protocols for advanced networking, TISPAN.

31. The system according to claim 19, wherein the first subsystem is an access subsystem of the communication system.

32. The system according to claim 31, wherein the access subsystem is other than in accordance with a general packet radio service, GPRS.

33. The system according to claim 31, wherein the access subsystem is a network attachment subsystem, NASS, in accordance with European Telecommunications Standards Institute (ETSI) specifications.

34. The system according to claim 19, wherein the second subsystem is a service subsystem of the communication system.

35. The system according to claim 34, wherein the service subsystem is an IP multimedia subsystem, IMS, in accordance with European Telecommunications Standards Institute (ETSI) specifications.

36. A network element of a first subsystem of a communication system comprising at least two subsystems, the network element being operable for an authentication of a subscriber of the communication system requiring authentication of the subscriber in any of the subsystems and being performed by means of a bundled subscriber authentication by using a first authentication in a first one of the subsystems for a second authentication in a second one of the subsystems, both the first authentication and the second authentication being based on subscriber identities.

37. The network element according to claim 36, comprising:
first means for storing a first subscriber identity of the first subsystem; and
first means for retrieving the first subscriber identity from the first means for storing.

38. The network element according to claim 37, wherein the first means for retrieving is configured to retrieve the first subscriber identity by means of a network level address of the subscriber.

39. The network element according to claim 36, further comprising address storing means for storing an address of a network element of the second subsystem to a subscription of the subscriber on a subscriber basis.

40. The network element according to claim 36, wherein the first subsystem is a network attachment subsystem, NASS, in accordance with European Telecommunications Standards Institute (ETSI) specifications.

41. The network element according to claim 36, wherein the network element is a connectivity session location and repository function, CLF.

42. A network element of a second subsystem of a communication system comprising at least two subsystems, the network element being operable for an authentication of a subscriber of the communication system requiring authentication of the subscriber in any of the subsystems and being performed by means of a bundled subscriber authentication by using a first authentication in a first one of the subsystems for a second authentication in a second one of the subsystems, both the first authentication and the second authentication being based on subscriber identities.

43. The network element according to claim 42, comprising:
second means for storing a second subscriber identity of the second subsystem; and
second means for retrieving the second subscriber identity from the second means for storing.

44. The network element according to claim 43, wherein the second means for retrieving is configured to retrieve the second subscriber identity by means of a private user identity of the subscriber.

45. The network element according to claim 42, wherein the second subsystem is an IP multimedia subsystem, IMS, in accordance with European Telecommunications Standards Institute (ETSI) specifications.

46. The network element according to claim 42, wherein the network element is a home subscriber server, HSS.

47. The network element according to claim 42, wherein the network element is a subscription locator function, SLF.

48. A network element of a first or second subsystem of a communication system comprising at least two subsystems, the network element being operable for an authentication of a subscriber of the communication system requiring authentication of the subscriber in any of the subsystems and being performed by means of a bundled subscriber authentication by using a first authentication in a first one of the subsystems for a second authentication in a second one of the subsystems, both the first authentication and the second authentication being based on subscriber identities.

49. The network element according to claim 48, comprising:
means for receiving a first subscriber identity of the first subsystem and a second subscriber identity of the second subsystem; and
means for comparing the first subscriber identity and the second subscriber identity.

50. The network element according to claim 49, further comprising:
means for checking whether the first subscriber identity and the second subscriber identity belong to a same subscriber.

51. The network element according to claim 48, further comprising:
means for receiving a first network level addressing realm of the subscriber from a first network element of the first subsystem and a second network level addressing realm of the subscriber from a second network element of the second subsystem; and
means for comparing the network level addressing realm from the first network element with the network level addressing realm from the second network element.

52. The network element according to claim 48, wherein the network element is a serving connection state control function, S-CSCF.

53. The network element according to claim 48, wherein the network element is a home subscriber server, HSS.

54. Computer program embodied on a computer readable medium loadable into a system or network element for performing the steps of claim 1.
